(19) United States
(12) Patent Application Publication
(10) Pub. No.: US 2014/0197717 A1
(43) Pub. Date: Jul. 17, 2014

(54) DRIVE UNIT FOR A REVOLVING DOOR WITH AN INTEGRATED BLOCKING DEVICE AND/OR BRAKING DEVICE

(71) Applicant: Sven BUSCH, Dortmund (DE)

(72) Inventor: Sven BUSCH, Dortmund (DE)

(21) Appl. No.: 14/153,829

(22) Filed: Jan. 13, 2014

(30) Foreign Application Priority Data
Jan. 14, 2013 (DE) 102013000420.9

(51) Int. Cl. H02P 3/04; E05F 15/10; H02K 1/14; H02K 1/27; H02K 11/00

(52) U.S. Cl. CPC H02P 3/04; H02K 1/2786; H02K 11/0068; H02K 1/14; E05F 15/106
USPC 310/68 D; 310/156.01; 310/77; 49/42

(57) ABSTRACT

A drive unit for a revolving door having a turnstile includes: an electronically commutated multipole motor having: (i) a disk-shaped or cup-shaped stator part configured to be arrangable at a stationary structural component part of the revolving door, (ii) a disk-shaped or cup-shaped rotor part configured to be gearlessly connectable to the turnstile of the revolving door, and (iii) an engagement device arranged between the stator part and the rotor part, the engagement device being configured to intervene in rotational movement of the rotor part. The stator part and the rotor part are in a plane-parallel arrangement with respect to one another.

### BACKGROUND OF THE INVENTION

1. Field of the Invention

The present invention is directed to a drive unit for a revolving door with an electronically commutated multipole motor and a revolving door with a drive unit of this type.

2. Description of the Related Art

DE 10 2010 024 108 A1 shows a generic drive unit for a revolving door with an electronically commutated multipole motor. The multipole motor is dish-shaped and has a round, flat base structure. The multipole motor has an output shaft connected to a turnstile of the revolving door, and the revolving door can be driven by the multipole motor.

Multipole motors are also known as torque motors and have coil elements that are arranged on a circular path and are in an oppositely facing relationship, for example, on the inner side, outer side or axially, to magnet elements, which are also arranged on a circular path so that a high-pole count, high-torque direct drive is formed. The rotor part of the multipole motor can be connected to the turnstile of the revolving door such that the rotational axis of the turnstile coincides with the rotational axis of the rotor part of the multipole motor. Accordingly, the turnstile can even be supported on the side of the multipole motor by the multipole motor itself, and the flat-cylindrical, compact multipole motor has the advantage that it can be favorably integrated in a revolving door, for example, on the floor side, but also, for example, on the ceiling side.

Turnstiles in revolving doors must be outfitted with a braking device that allows the rotation of the turnstile to be arrested quickly when a risk to persons passing through the revolving door is sensed. For this purpose, the revolving doors and particularly the turnstiles are often outfitted with sensor technology and if a risk to a person is sensed, determined delay values must be reached in order to stop the turnstile as quickly as possible. Electromotive braking actions may not be sufficient for this purpose, particularly when very high delay values of the turnstile must be reached for safety reasons.

EP 2 072 737 A2 shows a revolving door with a conventional drive unit comprising a motor and a gear unit. Located on the back side of the motor is a braking device that acts on the motor shaft, and a continuously adjustable braking force can be adjusted. The drive unit with the motor and gear unit and with the braking device is received in an installation space above the ceiling element of the revolving door, which must have a substantial build height for receiving the drive unit with the braking device. The braking device comprises a conventional brake caliper that encloses a brake disk so as to form the typical construction of a wheel disk brake. If a wheel disk brake constructed in this way were coupled with a multipole motor, the advantages of the installation of the multipole motor within a minimal space in the revolving door could no longer be realized in an advantageous manner.

### SUMMARY OF THE INVENTION

It is an object of the invention to further develop a drive unit for a revolving door that requires a small installation space and that comprises at least one engagement device for intervening in the rotational movement of the turnstile of the revolving door.

This object is met by a drive unit for a revolving door having an electronically commutated multipole motor, wherein the multipole motor has a disk-shaped or cup-shaped stator part that can be arranged at a stationary structural component part of the revolving door, and wherein the multipole motor has a disk-shaped or cup-shaped rotor part that can be gearlessly connected to a turnstile of the revolving door. The stator part and the rotor part are in a plane-parallel arrangement with respect to one another, and an engagement device is arranged between the stator part and the rotor part for intervening in the rotational movement of the rotor part at the stator part.

The invention is based on the idea of integrating an engagement device in the multipole motor so that it is possible to gearlessly connect the multipole motor, and particularly the rotor part of the multipole motor, to the turnstile of the revolving door. Consequently, no gear unit or other transmitting structural component need be provided between the rotor part and the turnstile at which an engagement device could be integrated for intervening in the rotational movement of the turnstile. The advantageous embodiment form of the multipole motor with two rotor parts and stator parts extending approximately plane-parallel to one another provides an installation space in which the engagement device can be received. In so doing, the engagement device can act against the rotor part from the inner side of the multipole motor and can provide an intervention in the rotational movement of the rotor part and, consequently, in the rotational movement of the turnstile.

In one aspect of the invention, in an advantageous manner, the ratio of height to diameter of the substantially round, flat base structure of the electronically commutated multipole motor can be at least 1:3, preferably at least 1:4, particularly preferably at least 1:5, and most preferably 1:8 or more. The ratio of height to diameter is given by the parallel spacing of the disk-shaped or cup-shaped stator part in relation to the disk-shaped or cup-shaped rotor part of the multipole motor to the diameter of the stator part and/or rotor part. The ratios of height to diameter of up to 1:8 or more can only be achieved in that the coil elements and magnet elements are arranged between the stator part and rotor part, without the engagement device, which is integrated between the stator part and the rotor part, increasing the required small overall height of the multipole motor. In this regard, it has been shown that even base structures of multipole motors reaching a ratio of height to diameter of more than 1:12 can be used as drives for revolving doors.

For example, in one aspect, the engagement device, as a blocking device for blocking the rotational movement of the rotor part, can be formed at the stator part, and the blocking device can be arranged in a stationary manner at the stator part and is formed so as to engage in the rotor part by positive engagement. The rotational movement of the rotor part at the stator part can be blocked by the blocking device, wherein the blocking action is achieved by a positive engagement between the stator part and the rotor part by the blocking device. By virtue of the fact that the turnstile of the revolving door is connected to the rotor part of the multipole motor so as to be rigid against rotation, the ability of the turnstile to rotate can also be blocked by the blocking device integrated in the multipole motor. The blocking of the turnstile may be necessary, for example, when persons are to be quickly prevented from entering the building by corresponding activation of the blocking device. The blocking device can be remotely triggered, for example, and the turnstile can be blocked so that there can be no rotation around its rotational axis even if manual force is applied.

According to one aspect of the invention, the blocking device can have, for example, an actuator and a blocking element that can be moved in a positively engaging manner into a receiving opening in the rotor part by the actuator. Moving the blocking element in a positively engaging manner into the receiving opening in the rotor part ensures that the turnstile is secured with respect to rotation without merely relying on a frictional engagement. The actuator of the blocking device can include, for example, a magnet coil, which acts on a magnet armature connected to the blocking element when the magnet coil is electrically activated and so that the blocking element carries out a lifting movement in particular. Accordingly, the blocking device can be activated by energizing the magnet coil, and the blocking element moves into the receiving opening in the rotor part through attraction of the magnet armature to the magnet coil. According to a constructional modification of the blocking device, the blocking device blocks when no current is supplied and the blocking element is only disengaged from the positive engagement in the receiving opening when the magnet coil is energized. As an alternative to a lifting movement of the blocking element, the blocking device can also be constructed differently, and a rotary magnet can also be provided. As an alternative to the embodiment of the blocking device based on a lifting magnet, the blocking device can be constructed by a motor with a gear unit such as is known, for example, from electric steering wheel locking devices for motor vehicles. Restraining torques of the turnstile of more than 1000 Nm, for example, can be achieved by the positive engagement of the blocking device.

According to an advantageous further aspect of the drive unit, the rotor part can have an engagement disk, and the engagement disk can have a receiving opening or preferably a quantity of receiving openings in which the blocking element can engage during a lifting movement. Alternatively, the receiving openings can also be incorporated directly in the main structural component part of the cup-shaped rotor part, and the receiving openings can be arranged along a circular path around the rotational axis of the engagement disk or rotor part so that the receiving openings are moved away under the lifting axis of the blocking element when the rotor part executes a rotational movement at the stator part. When the blocking device is activated and the blocking element moves out in direction of the receiving openings, the blocking element finally engages in one of the receiving openings.

The quantity of receiving openings for engagement of the blocking element can determine the number of and the kind of angular positions in which the turnstile may be locked. For example, at least twelve, preferably twenty-four, particularly preferably thirty-six, and at most preferably at least forty-eight receiving openings can be incorporated on the circular path in the engagement disk or in the rotor part itself, and the receiving openings can form through-holes or blind holes. Alternatively, the receiving openings can also be formed by teeth or the like so that a positive engagement between the engagement disk or the rotor part itself and the blocking element can be achieved in a different manner.

According to an advantageous further aspect of the drive unit according to the invention, a control unit can be provided that is received particularly in the area between the stator part and the rotor part of the multipole motor, and the control unit is constructed for activating the engagement device. Further, the control unit can be connected via an electric lead to an operator's module and/or interface module by which the engagement device can also be triggered, for example, by a person actuating the operator's and/or interface module. Further, the control unit can include a radio module so that the engagement unit can also be activated via wireless communication between the control unit and an external device, for example, with the reception area of a building, in order to deny a person access to the building, for example.

According to one aspect, a quantity of coil elements can be arranged between the stator part and the rotor part, which coil elements are received at the stator part. Further, a quantity of magnet elements can be arranged between the stator part and the rotor part, the magnet elements being arranged at the rotor part. In so doing, the coil elements can be arranged on a circular path at the stator part so that a coil ring is formed, such that the engagement device and in particular also the control unit are arranged in the area inside the coil ring.

According to a further advantageous aspect of the drive unit according to the invention, it can further be provided that the engagement device is constructed as a braking device for braking the rotational movement of the rotor part and stator part. For this purpose, at least one engagement device can form a blocking device and at least one further device can form a braking device. The braking device can likewise be arranged in a stationary manner at the stator part and can be designed to engage in the rotating rotor part in a frictionally engaging manner. For this purpose, the braking device can have an actuator and a braking element, for example. The braking element can be brought into frictional engagement against a disk-shaped and preferably annular portion of the rotor part by activating the actuator. For example, the annular portion at the rotor part can serve to receive the magnet elements arranged either inside or outside of the annular portion. The braking element can come into frictionally engaging contact at the inner side or outer side of the annular portion opposite to the magnet elements, and the occurring braking forces and normal forces preferably run radial to the rotational axis of the rotor part. The rotor part can be rotatably received at the stator part via a bearing arrangement, and braking counterforces which occur by the rotor part due to the effect of the braking element can be absorbed by the bearing arrangement. This results in a drum brake construction such as is applied in automotive technology.

By the braking device integrated in the multipole motor, the turnstile of the revolving door can be stopped extremely quickly. This is particularly important when a sensor arrangement of the revolving door is triggered by a person because, in this case, it would have to be taken into account that the person could collide with the turnstile and could possibly be injured in this way. While the turnstile can also be braked by the electric motor, the braking distance can be considerably reduced with the braking device. In particular, the aim is to brake the revolving wings of the turnstile over a maximum distance of 10 cm because this corresponds approximately to the elasticity distance of the rubber safety edges on the door wings, which form the sensor arrangement for detecting a collision, for example, with a person.

In accordance with another aspect, the present invention is further directed to a revolving door with a drive unit having an electronically commutated multipole motor with a disk-shaped or cup-shaped stator part arranged at a stationary structural component part of the revolving door and with a disk-shaped or cup-shaped rotor part gearlessly connected to a turnstile of the revolving door. The stator part and the rotor part are in a plane-parallel arrangement with respect to one another, and an engagement device is arranged between the stator part and the rotor part for intervening in the rotational movement of the rotor part at the stator part. The further features and accompanying advantages described in connection with the drive unit are likewise taken into account for the revolving door according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, further steps improving the invention are explained in more detail in connection with the description of preferred exemplary embodiments of the invention with reference to the drawings. In the drawings:

FIG. 1 is a schematic perspective view of a revolving door with a ceiling-mounted multipole motor having an engagement device;

FIG. 2 is a cross-sectional view through a multipole motor as a drive unit for a revolving door, in which an engagement device in the form of a blocking device is shown in the multipole motor;

FIG. 3 is a top view of an engagement disk as a component part of the rotor part; and

FIG. 4 shows a further exemplary embodiment of a multipole motor in cross section with a first engagement device formed as a blocking device and with a further engagement device formed as a braking device.

### DETAILED DESCRIPTION OF THE PRESENTLY PREFERRED EMBODIMENTS

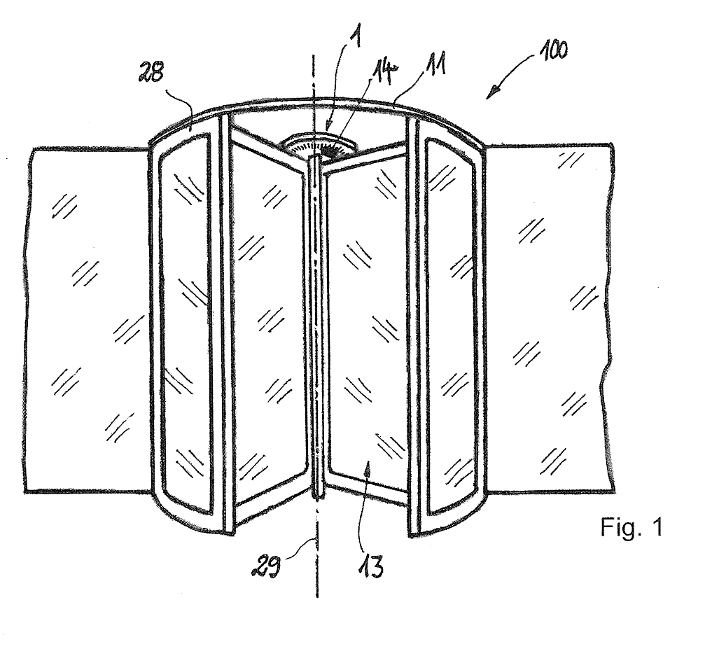

FIG. 1 is a schematic perspective view of a revolving door 100. The revolving door 100 has a frame 28, and a ceiling element of the frame 28 forms a structural component part 11 at which is arranged a multipole motor 1 that drives a turnstile 13 in rotation around a drive axis 29. Alternatively, the structural component part 11 can also form a floor-side component part of the revolving door 100 or of a building. The multipole motor 1 is accordingly located in a ceiling-mounted arrangement between the structural component part 11 and the turnstile 13. The multipole motor 1 has a flat-cylindrical, dish-like or disk-like basic form that makes it possible to arrange the multipole motor 1 on the ceiling.

In order to retard or block the rotational movement of the turnstile 13, an engagement device 14, only indicated schematically, is integrated in the multipole motor 1. The engagement device 14 makes it possible to retard the turnstile 13 in addition to an electromotive delaying or in addition to an electromotive blocking of the turnstile 13. Various embodiments are described in more detail in connection with exemplary embodiments in the following Figures.

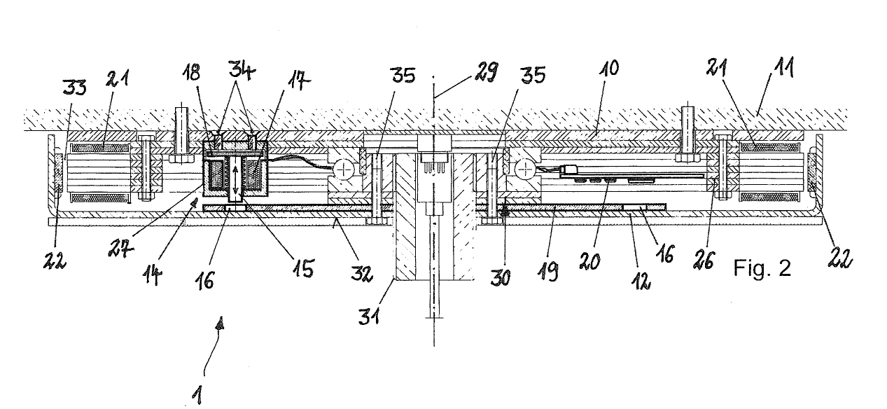

FIG. 2 is a cross-sectional view of a first embodiment example of a multipole motor 1 arranged at the underside of a structural component part 11. The multipole motor 1 has a disk-shaped stator part 10 and a cup-shaped rotor part 12. The rotor part 12 is arranged at the stationary stator part 10 by a bearing arrangement 30 so as to be rotatable around a drive axis 29, and the rotor part 12 comprises an output shaft 31 to which the turnstile 13 of the revolving door 100 can be connected. Alternatively, the turnstile 13 can be connected to the outer surface 32 of the rotor part 12 so as to allow the revolving wings of the turnstile 13 to be arranged directly at the rotor part 12 without requiring an output shaft 31.

Coil elements 21 and magnet elements 22 are arranged between the stator part 10 and the rotor part 12, and the coil elements 21 are received at an annular portion 26 at the stator part 10. The magnet elements 22 are received on the inner side in the cup-shaped rotor part 12 and surround the coil elements 21 arranged on a circular path while forming a circumferential air gap 33. The multipole motor 1 is accordingly formed as an external rotor, for example.

According to the disclosed embodiment of the invention, an engagement device 14 is arranged at the stator part 10, and the engagement device 14 is located between the stator part 10 and the rotor part 12 extending parallel to the stator part 10. The engagement device 14 is constructed as a blocking device 27 and screw elements 34 are provided for fastening the blocking device 27 to the stator part 10.

The rotor part 12 comprises an engagement disk 19 and when the blocking device 27 is activated, a blocking element 15 of the blocking device 27 can engage in receiving openings 16, which are incorporated in the engagement disk 19. The engagement disk 19 is rigidly connected to the base structure of the rotor part 12 by screw elements 35, and the screw elements 35 connect the bearing arrangement 30 to the rotor part 12 at the same time.

The receiving openings 16 are located on a circular path in the engagement disk 19 on a radius relative to the drive axis 29 that forms a surface normal on the engagement disk 19 and at the same time forms the axis of symmetry. Thus when the blocking element 15 engages in one of the receiving openings 16, the rotor part 12 is prevented from rotating at the stator part 10. At the same time, the turnstile 13 is blocked in the revolving door 100 by a torsionally rigid arrangement of the turnstile 13 at the rotor part 12.

To activate the blocking device 27, a control unit 20 is provided, which is likewise arranged in the area between the stator part 10 and the rotor part 12. A magnet coil 17 of the blocking device 27 can be energized by the control unit 20 so that a magnet armature 18 can execute a lifting movement and the magnet armature 18 is operatively connected to the blocking element 15. Accordingly, the pin-like blocking element 15 engages in the rotor part 12 when the magnet coil 17 is energized. Consequently, in the deenergized state of the blocking device 27, the rotor part 12 can rotate freely around the drive axis 29.

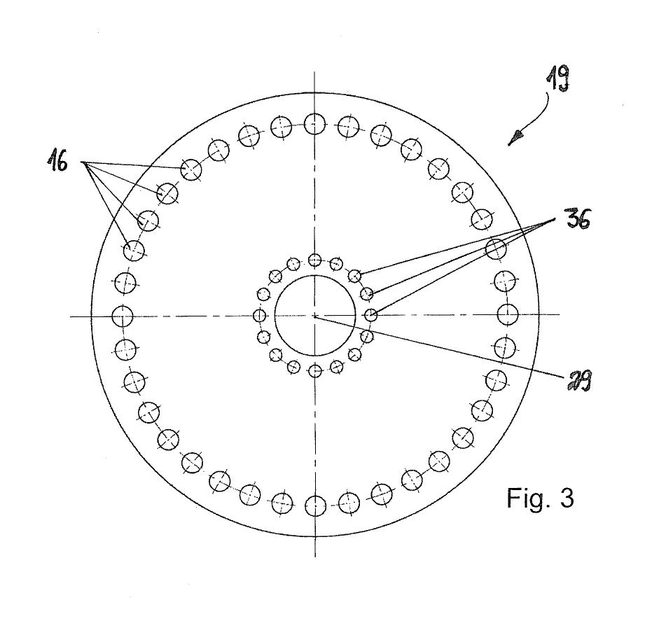

FIG. 3 shows a top view of the engagement disk 19 in which a quantity of receiving openings 16 are incorporated. The receiving openings 16 are located on a circular path in a radius extending around the drive axis 29 that coincides with the center axis of the engagement disk 19. Further, through-openings 36 are incorporated in the engagement disk 19 through which the screw elements 35 can extend.

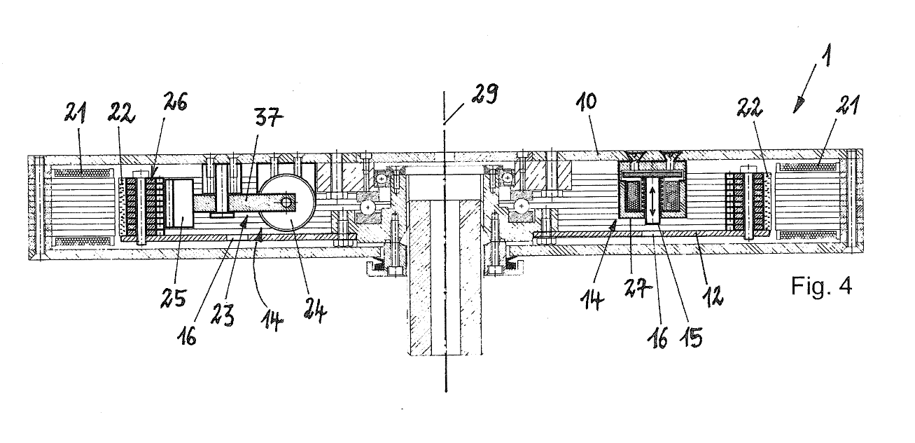

Finally, FIG. 4 shows a further exemplary embodiment of the multipole motor 1 with a stator part 10 and a rotor part 12 and coil elements 21 and magnet elements 22 arranged between the stator part 10 and rotor part 12. The coil elements 21 are arranged on the outer side at the stator part 10 so as to form a coil ring. The coil ring extends around the drive axis 29. Arranged on the inner side of the coil ring are magnet elements 22, which are arranged at an annular portion 26 of the rotor part 12. The stator part 10 has a closed construction and encloses the rotor part 12 in a plane-faced manner on both sides, the rotor part 12 having a base structure that extends parallel to the stator part 10 in spite of the closed stator part 10. Due to the arrangement of the magnet elements 22 inside the coil ring formed by the coil elements 21, the multipole motor 1 is formed as an internal rotor, for example.

The exemplary embodiment shows a first engagement device 14 constructed as a blocking device 27 and a second engagement device 14 configured to act as a braking device 23. Both engagement devices 14 are arranged in a stationary manner on the inner side of the stator part 10.

The blocking device 27 is shown with a blocking element 15, which can engage in receiving openings 16 in the same way as described already referring to FIG. 2. In this exemplary embodiment, the receiving openings 16 are incorporated, for example, in the base structure of the rotor part 12.

The engagement device 14 formed as braking device 23 has an actuator 24 that can act on a braking element 25 via a mechanical coupling device 37. When the actuator 24 is activated, the braking element 25 can act on the inner side against the annular portion 26 of the rotor part 12 to generate a braking torque between the stator part 10 and the rotor part 12. The annular portion 26 forms the portion of the rotor part 12 at which the magnet elements 22 are received.

Due to the braking device 23, the rotor part 12 can be braked from its rotational movement alternatively or in addition to an electromotive braking action of the multipole motor 1. The braking action relies on a frictional engagement between the braking element 25 and the inner side of the annular portion 26. In contrast, the blocking device 27 works by the engagement of the blocking element 15 in the receiving opening 16 by positive engagement and is preferably activated only when the rotor part 12 is already stationary or only rotates very slowly.

For example, in order to decelerate and block the rotating rotor part 12, the braking device 23 can first be activated as an alternative to or in addition to the electromotive braking action of the multipole motor 1 to retard the rotational movement of the rotor part 12 and, consequently, of the turnstile 13 of the revolving door 100. If the rotational movement has ended or the rotor part 12 only rotates very slowly, the blocking device 27 can be activated subsequently in order to definitively secure the rotor part 12 at the stator part 10 by positive engagement so that the turnstile 13 can also no longer rotate.

The invention is not limited with respect to its construction to the preferred embodiment example indicated in the preceding. On the contrary, there are a number of conceivable variants which can be made use of by the demonstrated solution also in fundamentally different arrangements. All of the features and/or advantages, including constructional details or spatial arrangements, stemming from the claims, the description or the drawings may be essential to the invention both by themselves and in the most widely varying combinations.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive unit for a revolving door (100) having a turnstile (13), the drive unit comprising:
an electronically commutated multipole motor (1) having:
(i) a disk-shaped or cup-shaped stator part (10) configured to be arrangable at a stationary structural component part (11) of the revolving door (100),
(ii) a disk-shaped or cup-shaped rotor part (12) configured to be gearlessly connectable to the turnstile (13) of the revolving door (100), and
(iii) an engagement device (14) arranged between the stator part (10) and the rotor part (12), the engagement device (14) being configured to intervene in rotational movement of the rotor part (12),
wherein the stator part (10) and the rotor part (12) are in a plane-parallel arrangement with respect to one another.

2. The drive unit according to claim 1, wherein the engagement device (14) comprises a blocking device (27) configured to block the rotational movement of the rotor part (12), the blocking device (27) being arranged in a stationary manner at the stator part (10) and configured to be engagable with at least a part of the rotor part (12) by positive engagement.

3. The drive unit according to claim 2, wherein:
the rotor part (12) comprises a receiving opening (16), and
the blocking device (27) comprises an actuator and a blocking element (15) movable, by the actuator, in a positively engaging manner into the receiving opening (16) in the rotor part (12).

4. The drive unit according to claim 3, wherein the actuator of the blocking device (27) comprises a magnet coil (17) configured to act on a magnet armature (18) connected to the blocking element (15), when the magnet coil (17) is electrically activated, so as to cause the blocking element (15) to carry out a lifting movement.

5. The drive unit according to claim 4, wherein the rotor part (12) has an engagement disk (19), the engagement disk (19) having the receiving opening (16) in which the blocking element (15) engages during the lifting movement.

6. The drive unit according to claim 1, further comprising a control unit (20) arranged between the stator part (10) and the rotor part (12) of the multipole motor (1), the control unit (20) being configured to activate the engagement device (14).

7. The drive unit according to claim 6, further comprises:
(a) a plurality of coil elements (21) arranged between the stator part (10) and the rotor part (12), the coil elements (21) being coupled to the stator part (10), and
(b) a quantity of magnet elements (22) arranged between the stator part (10) and the rotor part (12), the magnet elements (22) being coupled to the rotor part (12).

8. The drive unit according to claim 7, wherein the coil elements (21) are arranged on a circular path at the stator part (10) so as to form a coil ring, wherein the engagement device (14) and the control unit (20) are arranged in an area inside the coil ring.

9. The drive unit according to claim 1, wherein the engagement device (14) comprises a braking device (23) configured to brake the rotational movement of the rotor part (12).

10. The drive unit according to claim 9, wherein the braking device (23) is arranged in a stationary manner at the stator part (10) and is configured to engage the rotating rotor part (12) in a frictionally engaging manner.

11. The drive unit according to claim 9, wherein the braking device (23) has an actuator (24) and a braking element (25), wherein the braking element (25) can be brought into frictional engagement against a disk-shaped portion (26) of the rotor part (12) by activating the actuator (24).

12. A revolving door having a drive unit according to claim 1.

13. The drive unit according to claim 5, wherein the engagement disk (19) has a plurality of receiving openings (16) into which the blocking element (15) may engage during the lifting movement.

14. The drive unit according to claim 11, wherein the disk-shaped portion (26) is annular in shape.
